(19) United States
(12) Patent Application Publication
(10) Pub. No.: US 2013/0200305 A1
(43) Pub. Date: Aug. 8, 2013

(54) Process for Producing Water-Absorbing Polymer Particles

(71) Applicant: BASF SE, Ludwigshafen (DE)

(72) Inventors: Karin Flore, Floersheim-Dalsheim (DE); Thomas Daniel, Waldsee (DE); Agnes Voitl, Schifferstadt (DE); Gabriele Iffland, Heidelberg (DE)

(73) Assignee: BASF SE, Ludwigshafen (DE)

(21) Appl. No.: 13/759,147

(22) Filed: Feb. 5, 2013

Related U.S. Application Data
(60) Provisional application No. 61/595,214, filed on Feb. 6, 2012.

(51) Int. Cl. B01J 20/30

(52) U.S. Cl. CPC B01J 20/30
USPC 252/194

(57) ABSTRACT

A process for producing water-absorbing polymer particles by polymerizing an aqueous monomer solution or suspension comprising at least one ethylenically unsaturated monomer which bears acid groups and has been at least partly neutralized by addition of a neutralizing agent, wherein the neutralizing agent is filtered prior to the addition.

The present invention relates to a process for producing water-absorbing polymer particles by polymerizing an aqueous monomer solution or suspension comprising at least one ethylenically unsaturated monomer which bears acid groups and has been at least partly neutralized by addition of a neutralizing agent, wherein the neutralizing agent is filtered prior to the addition.

The production of water-absorbing polymer particles is described in the monograph “Modern Superabsorbent Polymer Technology”, F. L. Buchholz and A. T. Graham, Wiley-VCH, 1998, pages 71 to 103.

In the production of superabsorbents, preference is given to neutralizing the acrylic acid using concentrated sodium hydroxide solution. The latter may be contaminated with traces of iron or iron compounds, an average solution having impurities in the region of 3-10 ppm. Since even such small amounts of iron compounds can influence the polymerization process and adversely affect the product quality, as already described in the monograph “Modern Superabsorbent Polymer Technology”, F. L. Buchholz and A. T. Graham, Wiley-VCH, 1998, pages 71-72, it is necessary to remove or at least reduce the level of these impurities.

Various processes are known for removal of metal compounds from aqueous alkaline solutions.

For example, DE 10217096 describes the use of an electrolysis bath for purification of alkaline solutions. The metal content (excluding alkaline earth metals and alkali metals) of the purified solutions is not more than 10 ppb.

There are additionally known processes for purifying aqueous alkali solutions in which the solution is passed through activated carbon in granular or fibrous form.

EP 1 808 412, for example, describes the purification of aqueous alkaline solutions, especially for use in circuit board production, by means of activated carbon fibers. The activated carbon fibers are packed into a column and the solution to be purified is passed through. The purifying effect depends on the fiber used, but the content of metal compounds in the alkaline solution can be reduced down to a few ppb.

All known purifying processes either require a high level of apparatus complexity, for example requiring the setup of electrolysis apparatuses which make the purification of the solutions inconvenient and costly, or are based on the use of various forms of activated carbon, but the activated carbon can get into the filtrate and darkens the color thereof.

The production of water-absorbing polymer particles requires large amounts of a neutralizing agent, preferably sodium hydroxide solution, for neutralization. The costs and complexity for the purification of the sodium hydroxide solution therefore directly influence the production process and the costs of the end product. In addition, discoloration caused, for example, by activated carbon particles remaining in the neutralizing agent lowers the quality of the end product.

It was therefore an object of the present invention to provide an alternative, inexpensive, simple purifying process for aqueous alkaline solutions which are particularly suitable for use in the production of water-absorbing polymer particles of high product quality.

The object was achieved by a process for producing water-absorbing polymer particles by polymerizing a monomer solution or suspension comprising

a) at least one ethylenically unsaturated monomer which bears acid groups and may be at least partly neutralized by addition of at least one neutralizing agent,

b) at least one crosslinker,

c) at least one initiator,

d) optionally one or more ethylenically unsaturated monomers copolymerizable with the monomers mentioned under a) and

e) optionally one or more water-soluble polymers,

wherein the neutralizing agent is filtered by means of at least one filter prior to addition.

The neutralizing agent may, for example, be an aqueous solution of at least one alkali metal hydroxide, the alkali metal hydroxide being preferably potassium hydroxide, more preferably sodium hydroxide.

The filtration can be effected by means of a paper filter.

A suitable paper filter has a cellulose content of at least 90%, preferably of at least 95% and more preferably of at least 97%.

Likewise suitable as filter material are viscose fibers, modal fibers or lyocell fibers.

Both surface filtration and depth filtration, or a combination of both methods, are suitable for use in the process according to the invention.

For the inventive use, it is therefore possible, for example, to use fluted filters, round filters, filter fleeces, belt filters, pressurized belt filters, filter pouches, filter mats, filter plates, filter layers, bag filters, filter cartridges or candle filters.

Particularly suitable filters are those suitable for depth filtration, for example filter layers, filter candles, filter cartridges, filter mats composed of the abovementioned materials, cellulose being particularly suitable.

It may also be advantageous to use a combination of filters of the same kind or else a combination of different filters to increase the purifying effect.

It may additionally be advantageous to combine different filter materials in one filter.

Suitable filters for use in the process according to the invention are those having a mesh size of 1-6 μm, preferably 1.4 to 4 μm, more preferably 1.5 to 2 μm.

The removal of iron compounds can be improved by adding a filtration aid to the neutralizing agent prior to the filtration.

Suitable filtration aids are, for example, carbonate compounds, MgCO₃ and/or CaCO₃ being particularly suitable.

The production of the water-absorbing polymer particles is described in detail hereinafter:

The water-absorbing polymer particles are produced by polymerizing a monomer solution or suspension, and are typically water-insoluble.

The monomers a) are preferably water-soluble, i.e. the solubility in water at 23° C. is typically at least 1 g/100 g of water, preferably at least 5 g/100 g of water, more preferably at least 25 g/100 g of water and most preferably at least 35 g/100 g of water.

Suitable monomers a) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 and comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers a) is preferably at least 50 mol %, more preferably at least 90 mol %.

Most preferably, monomer a) is acrylic acid to an extent of at least 90 mol % and/or monomer a) has been neutralized to an extent of 30 to 80 mol %.

The monomers a) typically comprise polymerization inhibitors, preferably hydroquinone monoethers, as storage stabilizers.

The monomer solution comprises preferably up to 250 ppm by weight, preferably at most 130 ppm by weight, more preferably at most 70 ppm by weight, preferably at least 10 ppm by weight, more preferably at least 30 ppm by weight, especially around 50 ppm by weight, of hydroquinone monoether, based in each case on the unneutralized monomer a). For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1and DE 103 55 401 A1, or crosslinker mixtures, as described, for example, in DE 195 43 368 A1, DE 196 46 484 A1, WO 90/15830 A1 and WO 2002/032962 A2.

Preferred crosslinkers b) are pentaerythrityl triallyl ether, tetraallyloxyethane, methylenebismethacrylamide, 15-tuply ethoxylated trimethylolpropane triacrylate, polyethylene glycol diacrylate, trimethylolpropane triacrylate and triallylamine.

Very particularly preferred crosslinkers b) are the polyethoxylated and/or -propoxylated glycerols which have been esterified with acrylic acid or methacrylic acid to give di- or triacrylates, as described, for example, in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably 0.05 to 1.5% by weight, more preferably 0.1 to 1% by weight and most preferably 0.3 to 0.6% by weight, based in each case on monomer a). With rising crosslinker content, the centrifuge retention capacity (CRC) falls and the absorption under a pressure of 21.0 g/cm² (AUL0.3psi) passes through a maximum.

The initiators c) used may be all compounds which generate free radicals under the polymerization conditions, for example thermal initiators or redox initiators, photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is, however, preferably a mixture of the sodium salt of 2-hydroxy-2-sulfinatoacetic acid, the disodium salt of 2-hydroxy-2-sulfonatoacetic acid and sodium bisulfite. Such mixtures are obtainable as Brüggolite® FF6 and Brüggolite® FF7 (Brüggemann Chemicals; Heilbronn; Germany).

Ethylenically unsaturated monomers d) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate.

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight and most preferably from 50 to 65% by weight. It is also possible to use monomer suspensions, i.e. monomer solutions with excess monomer a), for example sodium acrylate. With rising water content, the energy requirement in the subsequent drying rises, and, with falling water content, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

Suitable reactors are, for example, kneading reactors or belt reactors. In the kneader, the aqueous polymer gel formed in the polymerization of an aqueous monomer solution or suspension is comminuted continuously by, for example, contrarotatory stirrer shafts, as described in WO 2001/038402 A1. To improve the drying properties, the comminuted aqueous polymer gel obtained by means of a kneader can additionally be extruded.

Polymerization on a belt is described, for example, in DE 38 25 366 A1 and U.S. Pat. No. 6,241,928. Polymerization in a belt reactor forms an aqueous polymer gel which has to be comminuted in a further process step, for example in an extruder or kneader.

The acid groups of the resulting aqueous polymer gels have been at least partially neutralized. Neutralization is preferably carried out at the monomer stage. This is typically accomplished by mixing in the neutralizing agent as an aqueous solution.

The degree of neutralization is preferably from 20 to 85 mol %, more preferably from 30 to 80 mol % and most preferably from 40 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof.

However, it is also possible to carry out neutralization after the polymerization, at the stage of the aqueous polymer gel formed in the polymerization. It is also possible to neutralize up to 40 mol %, preferably from 10 to 30 mol % and more preferably from 15 to 25 mol % of the acid groups prior to the polymerization by adding a portion of the neutralizing agent actually to the monomer solution and setting the desired final degree of neutralization only after the polymerization, at the aqueous polymer gel stage. When the aqueous polymer gel is neutralized at least partly after the polymerization, the aqueous polymer gel is preferably comminuted mechanically, for example by means of an extruder, in which case the neutralizing agent can be sprayed, sprinkled or poured on and then carefully mixed in. To this end, the gel mass obtained can be repeatedly extruded for homogenization.

The use of sodium hydroxide solution as a neutralizing agent is preferred.

In this context, it should be ensured that the neutralizing agent is essentially free of iron compounds, since iron compounds as an (unwanted) catalyst can influence the initiation of the polymerization process and adversely affect the product quality, as already described in the monograph “Modern Superabsorbent Polymer Technology”, F. L. Buchholz and A. T. Graham, Wiley-VCH, 1998, pages 71-72.

This is achieved by filtration of the aqueous solution of the neutralizing agent through filters. The filters preferably have a mesh size of 1 to 6 μm, preferably 1.4 to 4 μm, more preferably 1.5 to 2 μm.

The filters are preferably paper filters.

Suitable paper filters have a cellulose content of at least 90%, preferably at least 95% and more preferably at least 97%.

Likewise suitable as filter material are viscose fibers, modal fibers or lyocell fibers.

It may additionally be advantageous to combine different filter materials in one filter.

Both surface filtration and depth filtration, or a combination of both methods, are suitable for use in the process according to the invention.

For the inventive use, filters may be in any suitable form. They may, for example, be in the form of fluted filters, round filters, filter fleeces, belt filters, pressurized belt filters, filter pouches, filter mats, filter plates, filter layers, bag filters, filter cartridges or candle filters.

Particularly suitable filters are those suitable for depth filtration, for example filter layers, filter candles, filter cartridges, filter mats composed of the abovementioned materials, cellulose being particularly suitable.

Filter plates are used, for example, in filter presses.

It may also be advantageous to use a combination of filters of the same kind or else a combination of different filters to increase the purifying effect.

The iron content of the neutralizing agent can thus be reduced as a function of the mesh size of the filter paper used. Suitable choice of the filter allows reduction of the iron content of the neutralizing agent to at most 5 ppm, preferably at most 2 ppm, more preferably below 2 ppm, such that the neutralizing agent is suitable for use for the production of water-absorbing polymers of high product quality.

In addition, the filter material has an influence on the reduction of the iron content of the neutralizing agent. Cellulose is particularly preferred for reduction of the iron content, but related compounds such as viscose are also very suitable. It is assumed that filter materials having a high proportion of OH groups at the surface are generally suitable for use in the process according to the invention.

The filtration effect can additionally be improved when a filtration aid is added to the neutralizing agent prior to the filtration. This may be at least one carbonate compound, preferred filtration aids being MgCO₃ and CaCO₃ or mixtures of the two carbonates.

The use of at least one filtration aid allows reduction of the iron content of the neutralizing agent to at most 2 ppm, preferably at most 1 ppm and more preferably to below 1 ppm after the filtration.

In addition, it is possible to use filter cascades composed of several successive filters, in which case the mesh size of the filter paper in the cascade decreases from the present to the next filter in the cascade.

The use of filter cascades can also be combined with the use of filtration aids.

The aqueous polymer gel is then dried with a forced-air belt drier until the residual moisture content is preferably 0.5 to 15% by weight, more preferably 1 to 10% by weight and most preferably 2 to 8% by weight, the residual moisture content being determined by EDANA (European Disposables and Nonwovens Association) recommended test method No. WSP 230.2-5 “Moisture Content”. In the case of too high a residual moisture content, the dried polymer gel has too low a glass transition temperature T_{g} and can be processed further only with difficulty. In the case of too low a residual moisture content, the dried polymer gel is too brittle and, in the subsequent comminution steps, undesirably large amounts of polymer particles with an excessively low particle size are obtained (“fines”). The solids content of the gel before the drying is preferably from 25 to 90% by weight, more preferably from 35 to 70% by weight and most preferably from 40 to 60% by weight.

Thereafter, the dried polymer gel is ground and classified, and the apparatus used for grinding may typically be single or multistage roll mills, preferably two or three-stage roll mills, pin mills, hammer mills or vibratory mills.

The mean particle size of the polymer particles removed as the product fraction is preferably at least 200 μm, more preferably from 250 to 600 μm and very particularly from 300 to 500 μm. The mean particle size of the product fraction may be determined by means of EDANA (European Disposables and Nonwovens Association) recommended test method No. WSP 220.2-5 “Particle Size Distribution”, where the proportions by mass of the screen fractions are plotted in cumulated form and the mean particle size is determined graphically. The mean particle size here is the value of the mesh size which gives rise to a cumulative 50% by weight.

The proportion of particles with a particle size of at least 150 μm is preferably at least 90% by weight, more preferably at least 95% by weight, most preferably at least 98% by weight.

Polymer particles with too small a particle size lower the permeability (SFC). The proportion of excessively small polymer particles (“fines”) should therefore be low.

Excessively small polymer particles are therefore typically removed and recycled into the process. This is preferably done before, during or immediately after the polymerization, i.e. before the drying of the aqueous polymer gel. The excessively small polymer particles can be moistened with water and/or aqueous surfactant before or during the recycling.

It is also possible to remove excessively small polymer particles in later process steps, for example after the surface postcrosslinking or another coating step. In this case, the excessively small polymer particles recycled are surface postcrosslinked or coated in another way, for example with fumed silica.

When a kneading reactor is used for polymerization, the excessively small polymer particles are preferably added during the last third of the polymerization.

When the excessively small polymer particles are added at a very early stage, for example actually to the monomer solution, this lowers the centrifuge retention capacity (CRC) of the resulting water-absorbing polymer particles. However, this can be compensated for, for example, by adjusting the amount of crosslinker b) used.

When the excessively small polymer particles are added at a very late stage, for example not until an apparatus connected downstream of the polymerization reactor, for example an extruder, the excessively small polymer particles can be incorporated into the resulting aqueous polymer gel only with difficulty. Insufficiently incorporated, excessively small polymer particles are, however, detached again from the dried polymer gel during the grinding, are therefore removed again in the course of classification and increase the amount of excessively small polymer particles to be recycled.

The proportion of particles having a particle size of at most 850 μm is preferably at least 90% by weight, more preferably at least 95% by weight, most preferably at least 98% by weight.

The proportion of particles having a particle size of at most 600 μm is preferably at least 90% by weight, more preferably at least 95% by weight, most preferably at least 98% by weight.

Polymer particles of excessively large particle size lower the free swell rate. The proportion of excessively large polymer particles should therefore likewise be small.

Excessively large polymer particles are therefore typically removed and recycled into the grinding of the dried polymer gel.

To further improve the properties, the classified polymer particles can be surface postcrosslinked. Suitable surface postcrosslinkers are compounds which comprise groups which can form covalent bonds with at least two carboxylate groups of the polymer particles. Suitable compounds are, for example, polyfunctional amines, polyfunctional amido amines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230.

Additionally described as suitable surface postcrosslinkers are cyclic carbonates in DE 40 20 780 C1, 2-oxazolidinone and derivatives thereof, such as 2-hydroxyethyl-2-oxazolidinone, in DE 198 07 502 A1, bis- and poly-2-oxazolidinones in DE 198 07 992 C1, 2-oxotetrahydro-1,3-oxazine and derivatives thereof in DE 198 54 573 A1, N-acyl-2-oxazolidinones in DE 198 54 574 A1, cyclic ureas in DE 102 04 937 A1, bicyclic amido acetals in DE 103 34 584 A1, oxetanes and cyclic ureas in EP 1 199 327 A2 and morpholine-2,3-dione and derivatives thereof in WO 2003/031482 A1.

Preferred surface postcrosslinkers are ethylene carbonate, ethylene glycol diglycidyl ether, reaction products of polyamides with epichlorohydrin and mixtures of propylene glycol and 1,4-butanediol.

Very particularly preferred surface postcrosslinkers are 2-hydroxyethyl-2-oxazolidinone, 2-oxazolidinone and 1,3-propanediol.

In addition, it is also possible to use surface postcrosslinkers which comprise additional polymerizable ethylenically unsaturated groups, as described in DE 37 13 601 A1.

The amount of surface postcrosslinker is preferably 0.001 to 2% by weight, more preferably 0.02 to 1% by weight and most preferably 0.05 to 0.2% by weight, based in each case on the polymer particles.

In a preferred embodiment of the present invention, polyvalent cations are applied to the particle surface in addition to the surface postcrosslinkers before, during or after the surface postcrosslinking.

The polyvalent cations usable in the process according to the invention are, for example, divalent cations such as the cations of zinc, magnesium, calcium, iron and strontium, trivalent cations such as the cations of aluminum, iron, chromium, rare earths and manganese, tetravalent cations such as the cations of titanium and zirconium. Possible counterions are chloride, bromide, sulfate, hydrogensulfate, carbonate, hydrogencarbonate, nitrate, phosphate, hydrogenphosphate, dihydrogenphosphate and carboxylate, such as acetate, citrate and lactate. Aluminum sulfate and aluminum lactate are preferred. Apart from metal salts, it is also possible to use polyamines as polyvalent cations.

The amount of polyvalent cation used is, for example, 0.001 to 1.5% by weight, preferably 0.005 to 1% by weight and more preferably 0.02 to 0.8% by weight, based in each case on the polymer particles.

The surface postcrosslinking is typically performed in such a way that a solution of the surface postcrosslinker is sprayed onto the dried polymer particles. After the spraying, the polymer particles coated with surface postcrosslinker are dried thermally, and the surface postcrosslinking reaction can take place either during or after the drying.

The spray application of a solution of the surface postcrosslinker is preferably performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the position of the mixing shaft, i.e. horizontal mixers have a horizontally mounted mixing shaft and vertical mixers a vertically mounted mixing shaft. Suitable mixers are, for example, horizontal Pflugschar® plowshare mixers (Gebr. Lödige Maschinenbau GmbH; Paderborn; Germany), Vrieco-Nauta continuous mixers (Hosokawa Micron BV; Doetinchem; the Netherlands), Processall Mixmill mixers (Processall Incorporated; Cincinnati; USA) and Schugi Flexomix® (Hosokawa Micron BV; Doetinchem; the Netherlands). However, it is also possible to spray on the surface postcrosslinker solution in a fluidized bed.
The surface postcrosslinkers are typically used in the form of an aqueous solution. The penetration depth of the surface postcrosslinker into the polymer particles can be adjusted via the content of nonaqueous solvent and total amount of solvent.

When exclusively water is used as the solvent, a surfactant is advantageously added. This improves the wetting behavior and reduces the tendency to form lumps. However, preference is given to using solvent mixtures, for example isopropanol/water, 1,3-propanediol/water and propylene glycol/water, where the mixing ratio in terms of mass is preferably from 20:80 to 40:60.

The thermal drying is preferably carried out in contact driers, more preferably paddle driers, most preferably disk driers. Suitable driers are, for example, Hosokawa Bepex® Horizontal Paddle Dryers (Hosokawa Micron GmbH; Leingarten; Germany), Hosokawa Bepex® Disc Dryers (Hosokawa Micron GmbH; Leingarten; Germany), Holo-Flite® driers (Metso Minerals Industries Inc.; Danville; USA) and Nara Paddle Dryers (NARA Machinery Europe; Frechen; Germany). Moreover, fluidized bed driers may also be used.

The drying can be effected in the mixer itself, by heating the jacket or blowing in warm air. Equally suitable is a downstream drier, for example a shelf drier, a rotary tube oven or a heatable screw. It is particularly advantageous to effect mixing and drying in a fluidized bed drier.

Preferred drying temperatures are in the range of 100 to 250° C., preferably 120 to 220° C., more preferably 130 to 210° C. and most preferably 150 to 200° C. The preferred residence time at this temperature in the reaction mixer or drier is preferably at least 10 minutes, more preferably at least 20 minutes, most preferably at least 30 minutes, and typically at most 60 minutes.

In a preferred embodiment of the present invention, the water-absorbing polymer particles are cooled after the thermal drying. The cooling is preferably performed in contact coolers, more preferably paddle coolers and most preferably disk coolers. Suitable coolers are, for example, Hosokawa Bepex® Horizontal Paddle Coolers (Hosokawa Micron GmbH; Leingarten; Germany), Hosokawa Bepex® Disc Coolers (Hosokawa Micron GmbH; Leingarten; Germany), Holo-Flite® coolers (Metso Minerals Industries Inc.; Danville; USA) and Nara Paddle Coolers (NARA Machinery Europe; Frechen; Germany). Moreover, fluidized bed coolers may also be used.

In the cooler, the water-absorbing polymer particles are cooled to 20 to 150° C., preferably 30 to 120° C., more preferably 40 to 100° C. and most preferably 50 to 80° C.

Subsequently, the surface postcrosslinked polymer particles can be classified again, excessively small and/or excessively large polymer particles being removed and recycled into the process.

To further improve the properties, the surface postcrosslinked polymer particles can be coated or remoisturized.

The remoisturizing is preferably performed at 30 to 80° C., more preferably at 35 to 70° C., most preferably at 40 to 60° C. At excessively low temperatures, the water-absorbing polymer particles tend to form lumps, and, at higher temperatures, water already evaporates to a noticeable degree. The amount of water used for remoisturizing is preferably from 1 to 10% by weight, more preferably from 2 to 8% by weight and most preferably from 3 to 5% by weight. The remoisturizing increases the mechanical stability of the polymer particles and reduces their tendency to static charging. The remoisturizing is advantageously performed in the cooler after the thermal drying.

Suitable coatings for improving the free swell rate and the permeability (SFC) are, for example, inorganic inert substances, such as water-insoluble metal salts, organic polymers, cationic polymers and di- or polyvalent metal cations. Suitable coatings for dust binding are, for example, polyols. Suitable coatings for counteracting the undesired caking tendency of the polymer particles are, for example, fumed silica, such as Aerosil® 200, and surfactants, such as Span® 20.

The water-absorbing polymer particles produced by the process according to the invention have a moisture content of preferably 0 to 15% by weight, more preferably 0.2 to 10% by weight and most preferably 0.5 to 8% by weight, the moisture content being determined by EDANA (European Disposables and Nonwovens Association) recommended test method No. WSP 230.2-5 “Moisture Content”.

The inventive water-absorbing polymer particles have a centrifuge retention capacity (CRC), a free swell rate (FSR) and a permeability (SFC) which meet the conditions

FSR[g/gs]≧0.01·CRC[g/g]−0.08

and

SFC[10⁻⁷·cm³s/g]≧11000·exp(−0.18·CRC[g/g])

The water-absorbing polymer particles produced by the process according to the invention have a centrifuge retention capacity (CRC) of typically at least 15 g/g, preferably at least 20 g/g, more preferably at least 22 g/g, especially preferably at least 24 g/g and most preferably at least 26 g/g. The centrifuge retention capacity (CRC) of the water-absorbing polymer particles is typically less than 60 g/g. The centrifuge retention capacity (CRC) is determined by EDANA (European Disposables and Nonwovens Association) recommended test method No. WSP 241.2-5 “Centrifuge Retention Capacity”.

The inventive water-absorbing polymer particles have a permeability (SFC) of at least 80×10⁻⁷ cm³ s/g, preferably of at least 100×10⁻⁷ cm³ s/g and most preferably of at least 130×10 ⁷ cm³ s/g. The permeability is typically less than 500×10⁻⁷ cm³ s/g.

The permeability (SFC) of a swollen gel layer under a pressure of 0.3 psi (2070 Pa) is, as described in EP 0 640 330 A1, determined as the gel layer permeability of a swollen gel layer of water-absorbing polymer particles, the apparatus described on page 19 and in FIG. 8 in the aforementioned patent application having been modified such that the glass frit (40) is not used, and the plunger (39) consists of the same polymer material as the cylinder (37) and now comprises 21 bores of equal size distributed homogeneously over the entire contact area. The procedure and evaluation of the measurement remain unchanged from EP 0 640 330 A1. The flow is detected automatically.

The saline flow conductivity (SFC) is calculated as follows:

SFC[cm³s/g]=(Fg(t=0)×L0)/(d×A×WP)

where Fg(t=0) is the flow of NaCl solution in g/s, which is obtained using linear regression analysis of the Fg(t) data of the flow determinations by extrapolation to t=0, L0 is the thickness of the gel layer in cm, d is the density of the NaCl solution in g/cm³, A is the area of the gel layer in cm², and WP is the hydrostatic pressure over the gel layer in dyn/cm².

### EXAMPLES

For examples 1, 2 and 3, sodium hydroxide solution (50% by weight of NaOH) contaminated with 3.4 ppm of iron was used. Before conducting the experiment, all equipment was cleaned with 10% by weight NaOH solution (made from Suprapur® 30% by weight NaOH, from Merck KGaA, Darmstadt).

### Example 1

200 ml of the sodium hydroxide solution (50% by weight of NaOH) contaminated with 3.4 ppm of iron were filtered at room temperature through a fluted filter from Macherey-Nagel, retention range 1.6-2 μm.

After the filtration, the iron content of the filtrate was determined.

The iron content was 1.6 ppm.

### Example 2

100 ml of the sodium hydroxide solution (50% by weight of NaOH) contaminated with 3.4 ppm of iron were filtered at room temperature through a blue-band filter from Macherey-Nagel (MN 640d, diameter 150 mm, retention range 2-4 μm).

After the filtration, an iron content of 1.6 ppm was determined in the filtrate.

### Example 3 (with Filtration Aid)

Various volumes of a sodium hydroxide solution (50% by weight of NaOH) contaminated with 3.4 ppm of iron were admixed with different amounts of MgCO₃ (analytical grade, basic, heavy, from Sigma Aldrich) and shaken in a closed 250 m1 Erlenmeyer flask (oxygen-free) at room temperature for 24 h.

The solution was then left to stand for 2 days and the supernatant was filtered through a fluted filter from Macherey-Nagel, retention range 1.6-2 μm, and then the iron content of the filtrate was determined.

100 ml of sodium hydroxide solution were admixed with 1074 mg of MgCO₃.

The iron content of the supernatant was below 1 ppm.

200 ml of sodium hydroxide solution were admixed with 118 mg of MgCO₃.

The iron content of the supernatant was 0.4 ppm.

400 ml of sodium hydroxide solution were admixed with 125 mg of MgCO₃.

The iron content of the supernatant was 0.7 ppm.

### Examples 4 to 7

20 ml in each case of a 50% sodium hydroxide solution A (50% by weight of NaOH) were filtered under nitrogen atmosphere in order to avoid a reaction with the CO₂ in the air. This involved dripping the 50% sodium hydroxide solution through a filter paper folded in a funnel shape, which was within a funnel blanketed with nitrogen gas, into a 25 ml collecting vessel which was likewise blanketed with nitrogen gas.

The experiment was repeated with 4 different paper filters (examples 4 to 7).

The iron content of the 50% sodium hydroxide solution was determined by means of inductively coupled plasma mass spectroscopy (ICP-MS) before and after filtration.

The results are summarized in table 1.

### Example 8

As a comparison, 20 ml of a 50% sodium hydroxide solution (50% by weight of NaOH) were filtered by means of a glass filter (GF/A glass fiber filter), likewise under nitrogen atmosphere in order to avoid a reaction with the CO₂ in the air. This involved dripping the 50% sodium hydroxide solution through a glass fiber filter into a 25 ml collecting vessel which was likewise blanketed with nitrogen gas.

The iron content of the 50% sodium hydroxide solution was determined by means of inductively coupled plasma mass spectroscopy (ICP-MS) before and after filtration.

The iron content of the sodium hydroxide solution did not change as a result of the filtration by means of a glass fiber filter, which, with a pore size of 1.6 μm, had slightly finer pores than the finest-pore paper filter in these experimental series at 2 μm.

The result is listed in table 1.

TABLE 1
Iron content in sodium hydroxide solution (examples 4 to 8)

| | Filter | | Pore size | Fe content |
|---|---|---|---|---|
| Example | manufacturer | Filter type | [μm] | [ppm] |
| Starting solu- | — | — | — | 8 |
| tion A (50% | | | | |
| sodium hydrox- | | | | |
| ide solution) | | | | |
| 4 | Whatman | Paper filter | 20-25 | 5 |
| | | Grade 4 (Cat. | | |
| | | No. 1004240) | | |
| 5 | Whatman | Paper filter | 11 | 4 |
| | | Grade 1 (Cat. | | |
| | | No. 10001125) | | |
| 6 | Whatman | Paper filter | 3 | 2 |
| | | Grade 6 (Cat. | | |
| | | No. 1006125) | | |
| 7 | Macherey- | Paper filter | 2 | 2 |
| | Nagel | (blue-band | | |
| | | filter) No. 42 | | |
| 8 (comparison) | Whatman | Glass fiber | 1.6 | 8 |
| | | filter GF/A | | |

### Examples 9 to 13

The experimental procedure corresponds to that of experiments 4 to 8. The difference was that a 50% sodium hydroxide solution B (50% by weight of NaOH) which had been stored over very rusty iron sheets (blanketed with nitrogen gas) for 14 days was used. After storage, the undissolved iron components were filtered through a glass fiber filter (Schleicher Schüll GF8) to give a visually clear solution. This clear-filtered solution was used for the experiments (comparison B and experiments 9-13). The respective filtrations were each conducted with 20 ml of 50% sodium hydroxide solution B under nitrogen atmosphere in order to avoid a reaction with the CO₂ in the air.

The iron content of the 50% sodium hydroxide solution was determined by means of inductively coupled plasma mass spectroscopy (ICP-MS) before and after filtration.

The iron content of the sodium hydroxide solution did not change as a result of the filtration by means of a glass fiber filter, which, with a pore size of 1.6 μm, had slightly finer pores than the finest-pore paper filter in these experimental series at 2 μm.

The results are summarized in table 2.

TABLE 2
Iron content in 50% sodium hydroxide solution (examples 9 to 13)

| | Filter | | Pore size | Fe content |
|---|---|---|---|---|
| Experiment | manufacturer | Filter type | [μm] | [ppm] |
| Starting solu- | — | — | — | 34 |
| tion B (50% | | | | |
| sodium hydrox- | | | | |
| ide solution) | | | | |
| 9 | Whatman | Paper filter | 20-25 | 27 |
| | | Grade 4 (Cat. | | |
| | | No. 1004240) | | |
| 10 | Whatman | Paper filter | 11 | 19 |
| | | Grade 1 (Cat. | | |
| | | No. 10001125) | | |
| 11 | Whatman | Paper filter | 3 | 14 |
| | | Grade 6 (Cat. | | |
| | | No. 1006125) | | |
| 12 | Macherey- | Paper filter | 2 | 9 |
| | Nagel | (blue-band | | |
| | | filter) No. 42 | | |
| 13 | Whatman | Glass fiber | 1.6 | 36 |
| | | filter GF/A | | |

1. A process for producing water-absorbing polymer particles by polymerizing an aqueous monomer solution or suspension comprising
a) at least one ethylenically unsaturated monomer which bears an acid group and has been at least partly neutralized by addition of at least one neutralizing agent,
b) at least one crosslinker,
c) at least one initiator,
d) optionally one or more ethylenically unsaturated monomer copolymerizable with the monomer mentioned under a), and
e) optionally one or more water-soluble polymer, comprising filtering the neutralizing agent by means of at least one filter prior to the addition to the at least one ethylenically unsaturated monomer.

2. The process according to claim 1, wherein the neutralizing agent is an aqueous solution of at least one alkali metal hydroxide.

3. The process according to claim 2, wherein the alkali metal hydroxide is potassium hydroxide or sodium hydroxide.

4. The process according claim 1, wherein the filter is a paper having a cellulose content of at least 90% and/or viscose fibers and/or modal fibers.

5. The process according to claims 1, wherein the filter is in the form of a round filter, fluted filter, filter fleece, belt filter, pressurized belt filter, filter pouch, filter mat, filter plate, filter layer, filter bag, or filter candle.

6. The process according to claim 1, wherein the filter has a mesh size of 1 to 6 μm.

7. The process according to claims 1, wherein the filter has a mesh size of 1.4 to 4 μm.

8. The process according to claims 1, wherein the filter has a mesh size of 1.5 to 2 μm.

9. The process according to claim 1, wherein a filtration aid is added to the neutralizing agent prior to the filtration.

10. The process according to claim 9, wherein the filtration aid is at least one carbonate compound.

11. The process according to claim 10, wherein the filtration aid is MgCO₃ and/or CaCO₃.
